(19) United States
(12) Patent Application Publication
(10) Pub. No.: US 2023/0086549 A1
(43) Pub. Date: Mar. 23, 2023

(54) Electrochemical ammonia synthesis

(71) Applicant: Danmarks Tekniske Universitet, Kongens Lyngby (DK)

(72) Inventors: Suzanne Zamany Andersen, Kongens Lyngby (DK); Ib Chorkendorff, Kongens Lyngby (DK); Debashish Chakraborty, Kongens Lyngby (DK); Peter christian Kjærgaard Vesborg, Kongens Lyngby (DK); Jakob Kibsgaard, Kongens Lyngby (DK); Jens Kehlet Nørskov, Kongens Lyngby (DK); Vanessa Jane Bukas, Kongens Lyngby (DK)

(21) Appl. No.: 17/905,282

(22) PCT Filed: Mar. 5, 2021
(86) PCT No.: PCT/EP2021/055565

§ 371 Date: Aug. 30, 2022

(30) Foreign Application Priority Data
Mar. 5, 2020 (EP) 20161234.8

(51) Int. Cl. C25B 1/27; C01C 1/04; C25B 9/15; C25B 15/02

(52) U.S. Cl. CPC C25B 1/27; C01C 1/04; C25B 9/15; C25B 15/02

(57) ABSTRACT

The invention regards a method for electrochemical ammonia synthesis, comprising the steps of: providing at least one electrolysis cell; contacting the cathode with a source of lithium cations, nitrogen, and protons; and subjecting the cathode to a continuous pulsed cathode potential, including a pulsed cathodic current load, wherein the cathode potential is pulsed between the lithium reduction potential and a less negative cathode potential, whereby ammonia is synthesized.

### TECHNICAL FIELD

The present invention relates to a method for electrochemical ammonia synthesis, and an apparatus for said electrochemical ammonia synthesis.

### BACKGROUND

Ammonia is one of the most important necessities for modern society, and is currently the second most produced industrial chemical. It is primarily used as a fertilizer, enabling the explosive growth of the global population during the past century, as well as a reactant in the chemical industry. Recently, ammonia is also being considered as an energy carrier for renewable energy sources. The main advantage as an energy carrier lies in its ease of transportation, as ammonia can be liquefied and stored at comparatively milder conditions than hydrogen.

The production of ammonia currently relies on the Haber-Bosch process, which requires high temperatures of 400-500° C., high pressures above 100-150 bar, and a hydrogen source. Consequently, the Haber-Bosch process is highly energy demanding, resulting in ca. 1% of the global energy consumption, and since the hydrogen is typically supplied from steam-reformed natural gas, the process gives rise to significant CO₂ emissions. Additionally, the high-pressure reaction conditions require large centralized facilities, with a high cost of installation and cost for transportation to the point of use of the produced ammonia.

Alternatively, ammonia may be produced electrochemically by reduction of nitrogen (N₂) to ammonia (NH₃), as shown by equation 1, where the energy can be provided from renewable sources like wind or solar power:

N₂+6H⁺+6e⁻→2NH₃ (Eq. 1)

The electrochemical ammonia synthesis may be carried out under mild conditions, i.e. below 100° C. and at near atmospheric pressure. However, the process selectivity towards ammonia, and hence the faradaic efficiency of the process, will depend on the process parameters, including temperature, pressure, current supply and potential, and the types of reactants.

The electrochemical ammonia synthesis may be lithium mediated, as observed experimentally and illustrated in FIG. 1. The Li mediated process typically involves an aprotic solvent, a proton source, and a lithium salt, in addition to a nitrogen supply. When applying a potential of −3 V vs. reversible hydrogen electrode (RHE) and a current load, the Li ions in solution undergo reduction on the surface of the cathode, forming Li metal (shown in FIG. 1, to the left, as the lithium reduction). This potential is also referred to as the lithium reduction potential. The formed Li metal is extremely reactive, and is therefore able to split the strong triple bond and disassociate N₂, forming intermediate compounds, such as for example lithium nitride Li₃N, in a non-electrochemical reaction at room temperature (shown in FIG. 1, second image to the left). The proton source subsequently hydrogenates the intermediate compounds, e.g. lithium nitride, whereby ammonia may be formed and Li ions released to the solution (shown in FIG. 1, two images to the right). The exact mechanism is however not yet fully elucidated, but the process is known to reliably forms ammonia from N₂ and a proton source at ambient conditions with Faradaic efficiencies of around 10-20%.

The reaction line for converting Li ions (Li⁺) to metallic lithium (Li⁰), further to lithium nitride Li₃N as intermediate compound, and further into ammonia (NH₃) is also illustrated in the middle part of FIG. 2 (not balanced equations).

Simultaneously with the ammonia synthesis at the cathode, hydrogen evolution occurs at the cathode by reaction of metallic lithium (Li⁰) and the proton source (HA), as illustrated by equation 2 below.

Li⁰+2HA→Li⁺+2A⁻+H₂ (Eq. 2)

The hydrogen reaction competes with the ammonia synthesis, and thus affects the ammonia selectivity and faradaic efficiency. Initial faradaic efficiencies of 18.5% (at ambient pressure, and a current density of 8 mA/cm²) and 30% (at 10 bar, and a current density of 2 mA/cm²) may be obtained via the lithium mediated nitrogen reduction to ammonia.

However, the energy efficiencies are known to decrease rapidly within a few hours, due to degradation mechanisms at the cathode. The main degradation mechanism is speculated to be related to the intermediate lithium compounds, such as lithium nitride, which remains deposited, and decreases the efficiency. WO 2012/129472 [1] discloses that the cathode may be cleaned by washing with steam/water and subsequent drying, whereby the deposited lithium nitride may be removed and the cathode reused.

### SUMMARY

The present disclosure provides an electrochemical ammonia synthesis method with improved efficiency and stability, by use of a pulsed cathode potential, including a pulsed cathodic current load. The pulsed cathode potential may be obtained by cycling the potential of the cathode between a cation reduction potential, such as the lithium reduction potential, and a less negative potential, e.g. the potential corresponding to the cell open circuit voltage. The method is seen to provide faradaic efficiencies above 30% for up to 125 hours, and energy efficiencies of up to 7.2%.

The pulsed cathode potential, and the associated pulsed cathodic current load, implies that at periods of high negative cathode potential, e.g. at the lithium reduction potential, and periods of high cathodic current load, the cations/Li ions are reduced and reoxidised at the cathode, simultaneously with conversion of nitrogen and protons into ammonia. The pulsed operation further implies that at periods of lower negative cathode potential, e.g. where the cell voltage is OCP, and periods of no/low cathodic current load, the cathode is regenerated, and/or the cathode potential is regenerated.

Particularly improved efficiency and stability may be obtained when the cathode is contacted with a source of mediating cations, in addition to the reactants nitrogen and protons. For example, the electrolysis cells may comprise the source of cations e.g. as a part of the electrolyte, which may be a solvent electrolyte into which the cations are dissolved. Particularly high efficiencies have been seen for ammonia synthesis mediated by lithium cations, and electrolysis cells including lithium cations. The sources of nitrogen and/or protons also be comprises within the electrolysis cell, e.g. the electrolyte, or may be supplied from externally to the electrolysis cells.

A first aspect of the invention relates to a method for electrochemical ammonia synthesis, comprising the steps of:
providing at least one electrolysis cell,
contacting the cathode with a source of lithium cations, nitrogen, and protons, and
subjecting the cathode to a continuous pulsed cathode potential, including a pulsed cathodic current load, wherein the cathode potential is pulsed between the lithium reduction potential and a less negative cathode potential, whereby ammonia is synthesized.

In other embodiments of the disclosure, the cations are one or more metal cations, where the metal is selected from groups 1-13 of the periodic table and combinations thereof, more preferably the metal is selected from the group consisting of: alkali metals, alkali or alkaline earth metals, and/or transition metals, more preferably the metal is selected from groups 1, 2, 3 of the periodic table and combinations thereof, and most preferably the metal is selected from the group consisting of: lithium (Li), sodium (Na), potassium (K), magnesium (Mg), calcium (Ca), barium (Ba), yttrium (Y), and combinations thereof.

A further aspect of the disclosure relates to an apparatus for electrochemical ammonia synthesis configured for the method according to the first aspect. This may be obtained by an apparatus comprising the one or more electrolysis cells, and means to regulate the power source input to the electrolysis cells, such as a regulator.

Another aspect of the disclosure relates to an apparatus for electrochemical ammonia synthesis, comprising
at least one electrolysis cell having a cathode, said electrolysis cell connectable to at least one power source, and
at least one controller configured for regulating the power source input to the electrolysis cells
   wherein the apparatus is configured for
contacting the cathode with a source of lithium cations, nitrogen, and protons, and
subjecting the cathode to a continuous pulsed cathode potential, including a pulsed cathodic current load, wherein the cathode potential is pulsed between the lithium reduction potential and a less negative cathode potential.

It follows that the apparatus may be adapted for different types of electrolysis cells, and preferably the apparatus is adapted for electrolysis cells, which comprise a source of cations. Preferably, the cations are one or more metal cations, where the metal is selected from groups 1-13 of the periodic table and combinations thereof, more preferably the metal is selected from the group consisting of: alkali metals, alkaline earth metals, and/or transition metals, more preferably the metal is selected from groups 1, 2, 3 of the periodic table and combinations thereof, and most preferably the metal is selected from the group consisting of: lithium (Li), sodium (Na), potassium (K), magnesium (Mg), calcium (Ca), barium (Ba), yttrium (Y), and combinations thereof.

### DESCRIPTION OF DRAWINGS

The invention will in the following be described in greater detail with reference to the accompanying drawings.

FIG. 1 shows an embodiment of lithium mediated electrochemical nitrogen reduction to ammonia, according to the present disclosure.

FIG. 2 shows an embodiment of possible cathode reactions during lithium mediated electrochemical ammonia synthesis, according to the present disclosure.

FIG. 3 shows an embodiment of an electrolysis flow cell according to the present disclosure.

FIG. 4 shows photographic embodiments of cathodes used for electrochemical ammonia synthesis, where the cathode of (A) was exposed to a constant cathodic current load, and the cathode of (B) was exposed to pulsed cathodic current load.

FIG. 5 shows the electrode potentials as a function of time for lithium mediated ammonia synthesis under a constant cathodic current load of −2 mA/cm².

FIG. 6 shows the electrode potentials as a function of time for lithium mediated ammonia synthesis under a continuously pulsed cathodic current load, where the current load is cycled between −2 mA/cm² and 0 mA/cm².

FIG. 7 shows a close up of some of the cycles of FIG. 6.

FIG. 8 shows NMR data for the nitrogen content of the experimental setup.

### DETAILED DESCRIPTION

The invention is described below with the help of the accompanying figures. It would be appreciated by the people skilled in the art that the same feature or component of the device are referred with the same reference numeral in different figures. A list of the reference numbers can be found at the end of the detailed description section.

### Electrolysis Cell

Ammonia may be produced electrochemically by reduction of nitrogen (N₂) to ammonia (NH₃). In addition to nitrogen as reactant, protons and electrons are required as indicated by equation (1). The electrochemical reaction may further be mediated by the presence of additional substances. For example, the selectivity of the electrochemical production of ammonia may be promoted by the presence of cations, e.g. lithium cations, as well as specific solvents and solvent additives, into which the cations may be dissolved.

The reactants and substances taking part in the electrochemical ammonia synthesis are either continuously supplied from externally to the reaction site in the cell, or present and stored within the cell. For example, an ammonia electrolysis cell may be operated by externally supplied power, nitrogen, cations, and protons, e.g. supplied as hydrogen. The substances which are not directly consumed reactants, e.g. the cations, may be supplied or stored within the cell, e.g. in the form of an electrolyte comprising a solvent with dissolved cations and additives.

In an embodiment of the disclosure, the electrolysis cell is connectable to at least one power source, at least one nitrogen source, and/or hydrogen source. Preferably, the cell is further fluidly connectable to at least one proton source, and/or cation source. For example, the electrolysis cell have an electrolyte comprising a proton source and/or cation source.

Hence, electrochemical ammonia synthesis is carried out in an electrolysis cell, i.e. a device where an external voltage and/or current load, may be applied to drive the synthesis reaction. For example, when Li ions in a solution are subjected to a potential of −3 V vs. reversible hydrogen electrode (RHE), the so-called lithium reduction potential, including a current supply at the cathode, the Li ions are reduced to Li metal on the surface of the cathode by electrolysis.

The electrical potential is applied across the electrodes of the electrolysis cell, i.e. the anode and cathode, where the electrodes are separated by the electrolyte comprising the solution of Li ions. However, to precisely control the potential of the cathode, the cathode potential is measured by use of a reference electrode (RE). Hence, the reference electrode only controls, or more specifically only measures, the cathode potential and passes no current.

At the cathode, reduction can take place, and electrons are consumed to e.g. reduce Li ions to Li metal. Thus, the cathode is also referred to as the working electrode (WE), and the consumed electrons referred to as the cathodic current load. At the anode, oxidation takes place, and the corresponding amount of electrons are released e.g. by oxidation of hydrogen. Thus, the anode is also referred to as the counter electrode (CE), and the produced electrons or current may be referred to as an anode current load.

According to the present disclosure, the cathode potential is advantageously varied. For example, it may be changed between the lithium reduction potential, i.e. −3 V, and a less negative cathode potential, such as the cell voltage corresponding to the open circuit voltage. The open circuit voltage (OCV), also referred to as the open circuit potential (OCP), is the potential when no external load is connected to the cell, corresponding to the cathode potential, where the cathode current load is zero. Hence, at the lithium reduction potential the cathode potential is negative, and includes a cathodic current load, and at the less negative cathode potential, e.g. cell OCP, no cathodic current load is present.

A change in the cathode potential from e.g. the lithium reduction potential and to cell OCP may be referred to as one cycle. Advantageously, the cathode potential, and the associated cathodic current load, is operated cyclic, i.e. the cycle is repeated multiple times, and preferably repeated in a periodic manner without interruption of the operation cell. This operation may also be referred to as a continuously pulsed operation, comprising pulses of a first cathode potential, including a first cathodic current load, and pulses of a second cathode potential, including a second cathodic current load.

The electrolysis selectivity towards ammonia, and hence the faradaic efficiency of the process, will depend on the process parameters, including the voltage/current supply pattern, as well as the operational temperature, pressure, and the types of reactants. The energy efficiency will further depend on the electrolysis configuration and cell type, e.g. whether it is a single compartment cell or a flow cell.

In the present disclosure, the electrochemical ammonia synthesis is exemplified as being mediated by lithium ions. However, the skilled person will know that the synthesis may be similarly mediated by other cations, and/or additional cations, and their corresponding metal, having similar properties to lithium. Metals in the vicinity of lithium in the periodic table of elements may have similar solubility, reactivity, and/or reduction potentials as lithium. Thus, advantageously, the synthesis may be mediated by one or more metal cations selected from the groups 1-13 of the periodic table of elements. This means that the synthesis is mediated by one or more metals and their corresponding cations. Advantageously, the synthesis is mediated by one or more metal cations selected from the groups consisting of: alkali metals, alkali or alkaline earth metals, and/or transition metals. Advantageously, the synthesis is mediated by cations which are reduced to metal at a similar cation reduction potential as lithium, and/or which have similar reactivity towards nitridation and protonation, such as sodium (Na), potassium (K), magnesium (Mg), calcium (Ca), barium (Ba), yttrium (Y), and combinations thereof.

It also follows that the associated apparatus for the electrochemical ammonia synthesis may be adapted for different types of electrolysis cells, and preferably the apparatus is adapted for electrolysis cells, which comprise a source of cations. Preferably, the apparatus comprises electrolysis cells comprising a source of cations, e.g. an electrolyte comprising dissolved cations, which preferably are lithium cations.

In an embodiment of the disclosure, the cations are one or more metal cations, where the metal is selected from groups 1-13 of the periodic table and combinations thereof, more preferably the metal is selected from the group consisting of: alkali metals, alkali or alkaline earth metals, and/or transition metals, more preferably the metal is selected from groups 1, 2, 3 of the periodic table and combinations thereof, and most preferably the metal is selected from the group consisting of: lithium (Li), sodium (Na), potassium (K), magnesium (Mg), calcium (Ca), barium (Ba), yttrium (Y), and combinations thereof.

### Faradaic Efficiency

The Faradaic efficiency (FE) of an electrochemical ammonia synthesis is calculated based on the concentration, C_{NH3}, of synthesized ammonia in the electrolyte, which is measured via either a colorimetric or isotope sensitive method, along with the total electrolyte volume, V, after each measurement. This is compared with the total charged passed, Q, as shown in Equation 3, where F is Faraday's constant, and 3 is the number of electrons transferred during the reaction for each mole of NH₃.

$$F {E}_{N H 3} = \frac{3 \cdot F \cdot {C}_{N H 3} \cdot V}{Q} \qquad ( Eq . 3 )$$

### Energy Efficiency

The energy efficiency, η, of an electrochemical ammonia synthesis is based on the total amount of energy put into the system via the potentiostat, Eᵢₙ, and compared that to the energy contained in the total amount of ammonia produced during the experiment, Eₒᵤₜ, as shown in Equation 4.

$$η = \frac{{E}_{o u t}}{{E}_{i n}} \qquad ( Eq . 4 )$$

Eₒᵤₜ is defined by the free energy of reaction of ammonia oxidation to N₂ and water times the amount of ammonia produced, while Eᵢₙ is given by the total cell voltage between the counter electrode (CE) and working electrode (WE), multiplied by the current to get the instantaneous power, and integrated over time, as shown in Equations 5 and 6.

Eₒᵤₜ=ΔG_{R}·n_{NH3} (Eq. 5)

Eᵢₙ=∫(V_{CE}(t)−V_{WE}(t))·I(t)dt (Eq. 6)

### Continuous Deposition

In an embodiment of the disclosure, electrochemical ammonia synthesis experiments were carried out as described in Examples 1-2. Using the method described in Example 1, a comparative experiment was performed where a steady cathodic current load of −2 mA/cm² was applied, as described in Example 3. The steady cathodic current load implies continuous Li ion reduction and continuous Li metal deposition at the cathode, and the operation condition of the cell is therefore also denoted as the deposition potential.

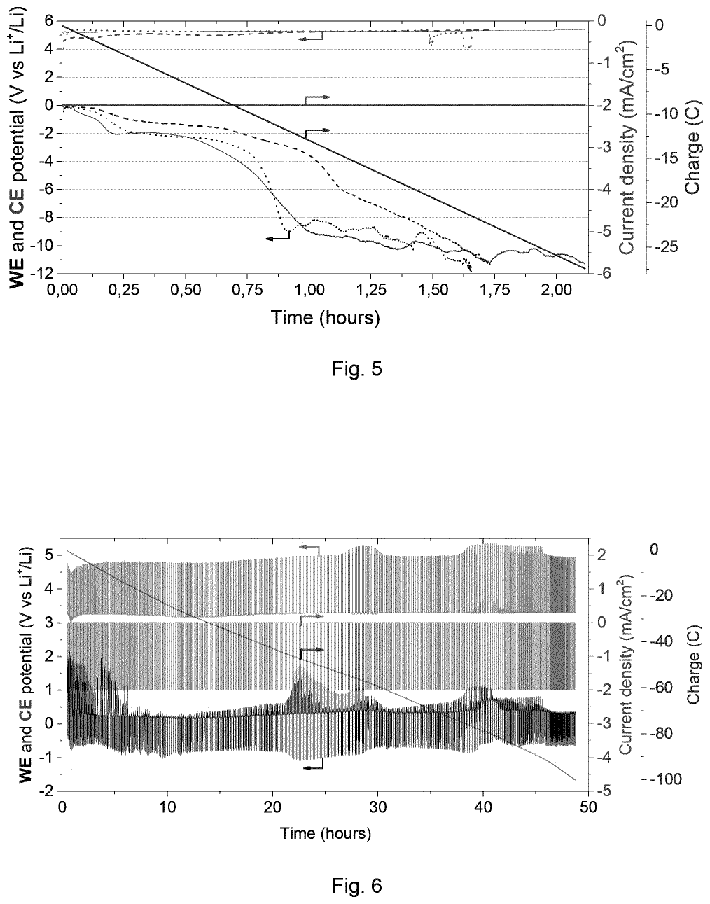

The resulting electrode potentials as a function of time for lithium mediated ammonia synthesis under the constant cathodic current load of ˜2 mA/cm² are shown in FIG. 5, are further described in Example 3. It is clearly seen that the working electrode (WE) potential, or the cathode potential, is not stable and degrades rapidly over time from 0 V vs Li⁺/Li to around ˜12 V vs Li⁺/Li. The decrease and degradation of the WE potential corresponds to an increase in the system energy input to sustain the desired current density of ˜2 mA/cm². After less than 1 hour of operation at ˜2 mA/cm² the system is overloaded.

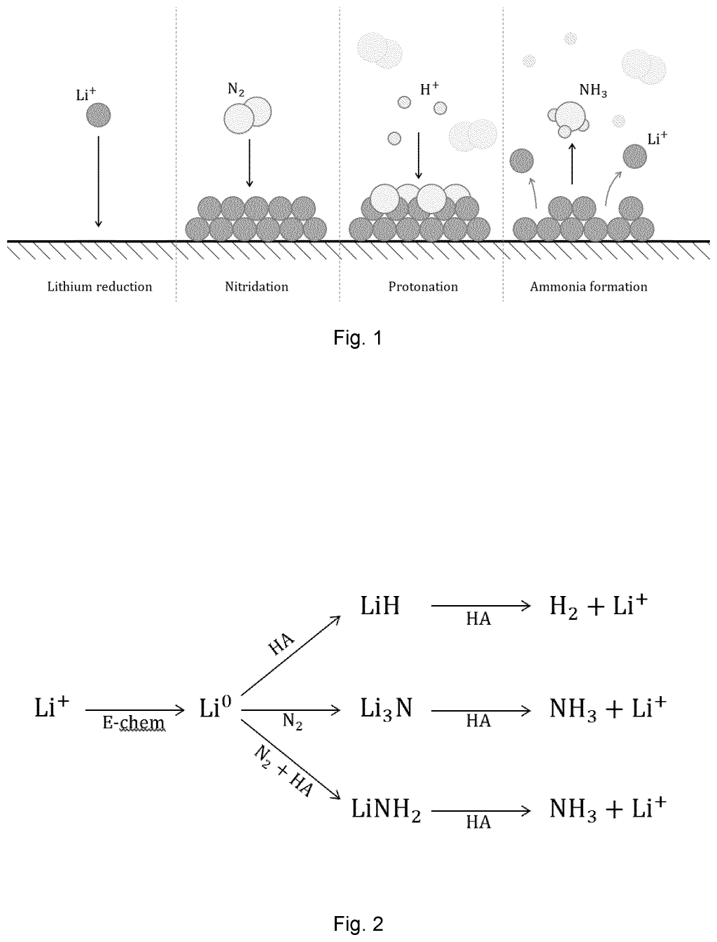

The cathode degradation mechanism is speculated to be related to the lithium salt reduction, where not all of the metallic lithium undergoes further reactions, e.g. nitridation, as illustrated by the possible reaction mechanism (not balanced) in FIG. 2. In addition, or in alternative, to nitridation into Li₃N, the metallic lithium may form Li-amides or hydrides, as illustrated by the lower and upper reaction paths in FIG. 2 (not balanced). However, the deposited metallic lithium which do not undergo further reactions, forms fresh lithium deposits that do not promote formation of ammonia and which are not released as lithium ions back to the solution, as illustrated in FIG. 1.

The deposits therefore decrease the overall efficiency of the system, as well as decrease the ionic conductivity of the solution as the lithium ions are depleted from solution, thereby increasing the overall resistance in the cell. The continuous deposition of lithium limits the up-scalability of the process, as a continued supply of lithium salt would be required to sustain synthesizing ammonia. This also leads to an accumulation of lithium species on the electrode surface, which slowly increases the needed potential to run the reaction.

The degradation mechanism is further supported by visual inspection of the cathodes. The electrode surface of the constant deposition experiment of Example 3 had big deposits of lithium species on the surface, as shown in FIG. 4A. The deposits may result in the observed passivation of the electrode and associated instability of the system as shown in FIG. 5.

### Pulsed Operation

In an embodiment of the disclosure, electrochemical ammonia synthesis experiments were carried out as described in Examples 1-2, using cyclic or pulsed cathode potential and current load. Using the method described in Example 1, the cathode current load was pulsed between ˜2 mA/cm² and 0 A, corresponding to cathode potential pulses between the lithium reduction potential and OCV. The experiments are further described in Example 4. The pulsed operation implies alternating periods of Li deposition and no deposition.

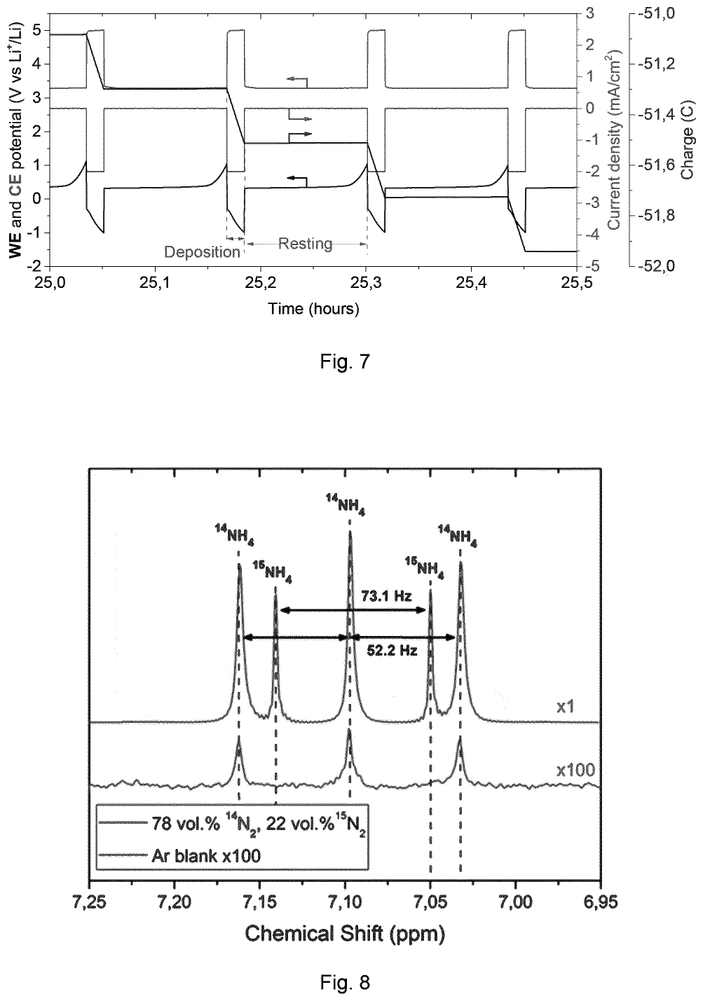

The resulting electrode potentials as a function of time for lithium mediated ammonia synthesis under the pulsed cathodic current load are shown in FIGS. 6-7. FIG. 6 shows cycling between ˜2 and 0 mA/cm² (lighter grey curve, related to the grey y-axis to the right), for a total of 100 C of charge passed (black curve, related to the black y-axis to the right). In comparison to the constant deposition of FIG. 5, the cathode potential, or working electrode (WE) potential (black curve, related to the y-axis to the left), is seen to be stable around a potential of 0 V vs Li⁺/Li over the tested 50 hours. A long term experiment was further carried out, where a similar working electrode stability was observed for 125 hours, as further described in Example 5.

FIG. 7 shows a close up of the cycling. In agreement with FIG. 5, it is seen that immediately upon switching to a deposition current of ˜2 mA/cm² (light gray curve, related to the grey y-axis to the right), the cathode degrades and the WE potential (black curve, related to the left y-axis) decreases. However, when the current is changed to zero, corresponding to the cell potential is OCV, the cathode potential is seen to be regenerated and stabilise around −3 V.

The regeneration of the degraded cathode during the periods of cell OCV, is speculated to be due removal of the build-up lithium species on the surface of the electrode. The resting time between the deposition pulses may allow the lithium to react fully with nitrogen in solution significantly prevented the WE potential from drifting cathodic over time. Hence, the cycling procedure stabilizes the WE potential because it “resets” the surface by removing the deposited material, and replenishes the lithium in the solution, and produces ammonia. This is further supported by visual inspection of the cathodes. The electrode surface of the pulsed experiment of Example 4 shown in FIG. 4B was seen to be free of the big deposits of lithium species that was present on the surface of the cathodes of Example 3, cf. FIG. 4A.

The Faradaic efficiency also increases with the continuous cycling method, as charge is not wasted on forming unreactive lithium deposits. Furthermore, the overall energy efficiency is improved, due to the decrease in needed potential to sustain the same current, i.e. the average WE potential is lower. Moreover, by cycling the potential from a very negative lithium reducing potential, to a less negative potential at which lithium is not reduced, while potentially still synthesizing ammonia, the Faradaic and energy efficiency is further increased, since ammonia may be formed at potentials less negative than −3 V vs RHE.

The improvement in Faradaic efficiency and energy efficiency, as well as the efficiency of the cathode regeneration, will depend on the cyclic or pulsed operation patterns. Further, for operational simplicity, the pulsed operation is regular and periodical, i.e. similar pulse sizes and durations are applied. Advantageously, the cathode potential, including the cathodic current load, is changed between two configurations, such that the cathode potential is pulsed between a first cathode potential, including a first cathodic current load, and a second cathode potential, including a second cathodic current load. Further advantageously, the cathode potential may be pulsed between the lithium reduction potential, and a less negative cathode potential, such as the potential corresponding to the cell OCV.

In an embodiment of the disclosure, the cathode potential is pulsed between a first cathode potential, including a first cathodic current load, and a second cathode potential, including a second cathodic current load. In a further embodiment, the cathode potential is pulsed between the cation reduction potential and a less negative cathode potential. In a further embodiment, the cathode potential is pulsed between the lithium reduction potential and a less negative cathode potential. In a further embodiment, the cathode potential is pulsed between the lithium reduction potential and the cell OCP.

It was surprisingly found that by increasing/decreasing the current load of the pulses and the duration of the pulses, the Faradaic efficiency, energy efficiency, and cathode regeneration, may be further improved. For example, advantageously, the duration of the pulses at the second cathode current load may be longer than the duration of the pulses at the first cathode current load.

In an embodiment of the disclosure, the duration of the pulses at the first cathode potential is between 0.5-60 min, more preferably between 0.7-30 min, and most preferably between 0.8-10 min, such as 1 or 2 min. In a further embodiment, the duration of the pulses at the second cathode potential is between 1-120 min, such as 1 or 2 min, more preferably between 2-60 min, and most preferably between 3-30 min, such as 3-5 or 10 min.

In an embodiment of the disclosure, the pulses of at the first cathodic current load has a duration of between 0.5-60 min, more preferably between 0.7-30 min, and most preferably between 0.8-10 min, such as 1 or 2 min. In a further embodiment, the pulses at the second cathodic current load has a duration of between 1-120 min or 5-120 min, such as 1 or 2 min, more preferably between 2-60 min or 6-60 min, and most preferably between 3-30 min or 7-30 min, such as 8 or 10 min.

It was further found that by increasing/decreasing the current load of the pulses, as well as the relative current load between the pulses, the Faradaic efficiency, energy efficiency, and cathode regeneration, may be further improved. For example, advantageously, the first cathodic current load is below −1 mA/cm², preferably around −100 mA/cm², and the second cathodic current load is −0.5 mA/cm², preferably 0 mA/cm² or even positive. When the second cathodic current is negative or zero, the pulsed operation may be referred to as pulsating DC. When the second cathodic current is positive, the pulsed operation may be referred to as pulsating AC.

In an embodiment of the disclosure, the pulsed cathodic current load is pulsating DC and/or pulsating AC. In a further embodiment, the pulses at the first cathodic current load has a current density below −1 mA/cm², such as −2, −5, or −10 mA/cm², more preferably above −50 mA/cm2, such as −60, −70, −80, −90, or −100 mA/cm². In a further embodiment, the pulses at the second cathodic current load has a current density above −0.5 mA/cm², such as 0 mA/cm² or 0.1 mA/cm².

### Additives, Reactants and Conditions

The faradaic efficiency of the process and the energy efficiency, will depend on other process parameters than the voltage/current pattern. For example, it was found that surprisingly high efficiencies may be obtained at mild temperature and pressure conditions, such as temperatures between 10-150° C., and/or a pressure which is equal to or below 20 bar.

In an embodiment of the disclosure, the temperature is between 10-150° C., more preferably between 20-130° C., and most preferably between 25-120° C., such as 50 or 100° C. In a further embodiment, the pressure is equal to or below 20 bar, such as 15, 10, 5, 1 bar or ambient pressure.

The faradaic efficiency of the process and the energy efficiency, will also depend on the reactant type and concentrations, as well as their accessibility and costs. For example, certain reactants were found advantageous as sources of Li ions, nitrogen, and protons. Furthermore, to ensure sufficient concentration of the reactants, the reactants may be supplied via a filter, e.g. protons may be supplied to the cathode via a proton exchange membrane.

Since the cations are not consumed and regenerated during the ammonia synthesis, the source of cations is advantageously comprised within the electrolysis cell, e.g. as part of a liquid electrolyte. Hence, the cation source is stored within the cell from which it may be supplied to the reaction sites. The liquid may be a molten salt or a solution comprising the cations, such as lithium cations. To improve the mediation and reaction kinetics and selectivity for the ammonia synthesis, a cation concentration which is sufficient for facilitating the mediation, and which at the same time do not impede the availability of other reactants at the reaction sites, is further advantageous. For example, for a solvent electrolyte, the lithium concentration is preferably between 0.1-3 M.

In an embodiment of the disclosure, the source of Li ions is selected from the group consisting of: molten Li salt, Li solutions, and combinations thereof, such as LiClO₄ solutions. In a further embodiment, the solutions has a Li concentration below 3 M or 1 M, such as 0.1, 0.2, 0.5, or 2 M.

The source of nitrogen is advantageously continuously supplied from externally to the cell, such that the consumed nitrogen is continuously replaced and the synthesis may be carried out continuously. Nitrogen is easily accessible as air, which comprises ca. 78 vol % N₂. However, the Faradaic efficiency will depend on the nitrogen concentration. Hence, advantageously the nitrogen source is pressurized nitrogen, and/or oxygen separated or purified nitrogen. To easily provide the nitrogen at the electrochemical reaction sites, the gaseous nitrogen may be supplied as gas to the liquid electrolyte, where it liquidly dissolved.

In an embodiment of the disclosure, the source of nitrogen is selected from the group consisting of: gaseous N₂, liquidly dissolved N₂, and combinations thereof.

The source of protons may also be continuously supplied from externally to the cell, such that the consumed protons are continuously replaced and the synthesis may be carried out continuously. For example, gaseous hydrogen may be supplied to an anode of the electrolysis cell, where the hydrogen is oxidized to protons that are dissolved in the liquid electrolyte. Alternatively, the source of protons may be supplied or stored within the cell, e.g. as part of an electrolyte which acts as a proton source or comprises dissolved protons. To further improve the reaction kinetics and selectivity for the ammonia synthesis, a sufficient proton concentration is desired. This may for example be obtained by the dissolved protons being transferred to the reaction sites at the cathode via a proton exchange membrane.

In an embodiment of the disclosure, the source of protons is selected from the group consisting of: gaseous H₂, liquidly dissolved H₂, apropic solvents, ethanol (EtOH), alkyl alcohols, especially tent-butanol, perfluorinated alcohols, polyethyleneglycols, ethanethiol, alkyl thiols, alkyl ketones, alkyl esters, and combinations thereof. In a further embodiment, the concentration of the protons within the proton source is between 0.01-100 vol %, more preferably between 0.01-5 vol %, and most preferably between 0.05-3 or 0.1-2 vol %. In a further embodiment, the source of protons is combined with a proton exchange membrane.

The reaction kinetics and the selectivity of the ammonia synthesis at the cathode, also depends on the simultaneous electrochemical reactions occurring, e.g. the competing hydrogen evolution which may occur at the cathode, as described in equation (2). To improve the ammonia selectivity, the method or the electrolysis cell advantageously comprises a liquid electrolyte comprising an essentially aprotic solvent, such as tetrahydrofuran (THF) or propylene carbonate, or any organic carbonates, which can be diethyl carbonate, ethyl methyl carbonate, ethylene carbonate and variations of these.

In an embodiment of the disclosure, the method or electrolysis cell comprises an essentially aprotic solvent, selected from the group of: tetrahydrofuran (THF), oxane, diethyl ether, dipropyl ether, diglyme, dimethoxyethane, triglyme, tetraglyme, polyethyleneglycol alkyl ethers, dioxane, organic carbonates, e.g. dimethyl carbonate, ethylene carbonate, diethyl carbonate, ethyl methyl carbonate, propylene carbonate, dialkyl carbonates, butyrolactone, cyclopentanone, cyclohexanone, sulfolane, ethylene sulfate (DTD), trimethylglycerol, and mixtures thereof, and preferably is selected from the group of: tetrahydrofuran, organic carbonates, propylene carbonate, and mixtures thereof.

By the term essentially aprotic is meant that the electrolyte may comprise a mixture of the aprotic solvent and the proton source, whereby the electrolyte solvent is essentially or near aprotic. For example, the electrolyte may comprise a mixture of THF with 1 vol % ethanol as proton source.

In a further embodiment, the aprotic solvent is selected from the group consisting of: tetrahydrofuran (THF), ethanol (EtOH), and combinations thereof, such as THF-1 vol % EtOH or THF with 1 vol % EtOH. In an embodiment of the disclosure, the source of protons is combined with a proton exchange membrane.

In addition to specific solvents, the selectivity and stability of the electrochemical production of ammonia may be further promoted by the presence of solvent additives. For example, additives which may prevent solvent degradation under the operational potential and current loads, are preferably included. Such additives are preferably included in a suitable concentration, which is typically below 5 vol % of the solvent.

In an embodiment of the disclosure, the essentially aprotic solvent comprises one or more additives selected from the group of: perfluorinated hydrocarbons, perfluorinated ethers, highly fluorinated organic tetrakisalkyl phosphonium perfluorinated phosphates, tetrakisalkyl phosphonium perfluoroalkyl sulfonates, tetrakisalkyl phosphonium perfluoroalkyl carboxylates, crown ethers, and mixtures thereof, wherein preferably the concentration of the additives is between 0-100 vol %, more preferably between 0.01-5 vol %, and most preferably is between 0.05-3 or 0.1-2 vol %.

### Flow Cell

The electrochemical ammonia synthesis may be carried out in any type of electrolysis cell. Advantageously, the synthesis is done in a single compartment cell, as further described in Examples 1-5, or a flow cell, as described in Example 6.

In an embodiment of the disclosure, the electrolysis cell is selected from the group consisting of: single compartment cells, and flow cells.

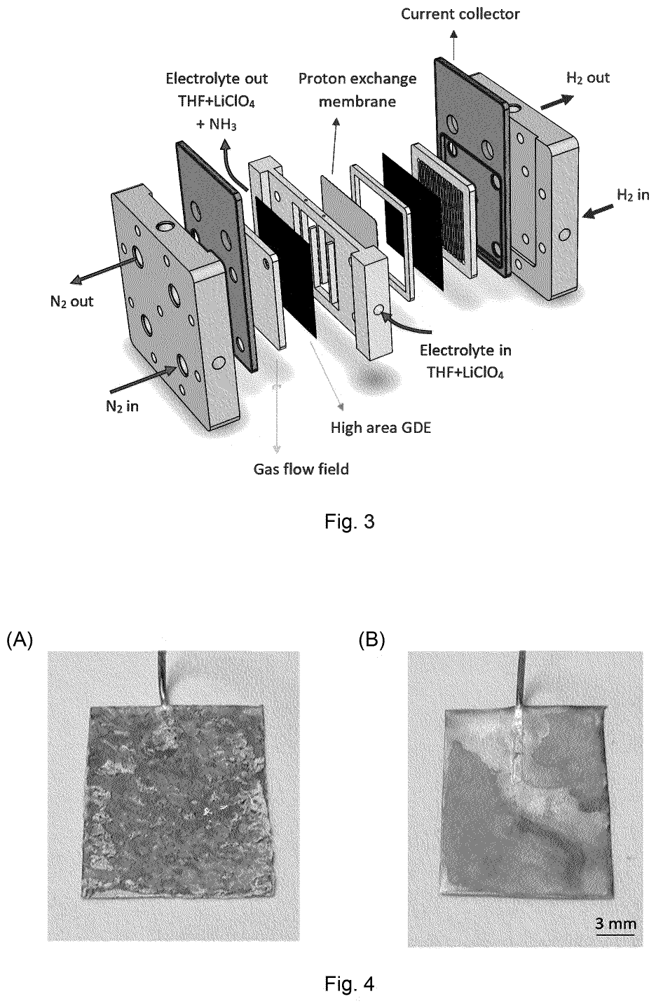

FIG. 3 shows an embodiment of a flow cell for electrochemical ammonia synthesis, where nitrogen is supplied to the electrolyte as a continuous gas flow, and hydrogen is supplied as a continuous gas flow. For flow batteries, the chemical reactants and products are fluids which are stored outside the cell and fed by pumps into the cell to store electricity, e.g. by producing ammonia. Thus, the storage capacity and ammonia production capacity depend on the size of the storage tank or container. The chemical reactants are continuously supplied from an external source to the cell, and the products (e.g. ammonia) are extracted to a storage outside the system. The reactants and products are charge-neutral species, such as hydrogen, nitrogen and ammonia. The storage tanks can also be open for continuous flow to an external source or storage, i.e. corresponding to a flow battery with infinite capacity.

The need for voluminous tanks or containers to store reactants and/or products, and the need for flow controlling means ensuring the essential flow of fluid and/or gaseous reactants and products to and from the cell, influences the energy density and energy efficiency of the system. The flow controlling means, also known as balance-of-system components, may include a number of compressors, expanders, condensers, and pumps.

### Apparatus

The electrolysis cells may be assembled into an apparatus connectable to one or more independent or decentralized power sources, which advantageously are renewable power sources such as wind power, hydropower, solar energy, geothermal energy, bioenergy, and mixtures thereof. Thus, the apparatus may be operated as an on-site ammonia production unit at a decentralised location, and the apparatus may further be adapted to be mobile, and to synthesize ammonia in amounts of 0.01-10 kg/day, more preferably 0.1-10 kg/day, and most preferably 0.1-5 kg/day, such as up to 1, 2, 3, or 4 kg/day, with a Faradaic efficiency above 50%, and operated at current loads equal to or above 100 mA/cm².

An on-site, decentralised ammonia production unit, further has the advantage that voluminous tanks or containers for storing the produced ammonia product may be avoided or reduced. Due to the controllable and restricted amount of power, and thus corresponding restricted amounts of synthesized ammonia per day, the ammonia may be extracted from the electrolysis cell and directly distributed to a site of demand and further matched to the demand. For example, the ammonia may be extracted from the electrolyte of the cell, and continuously supplied to an irrigation system of a greenhouse or farm, thereby providing fertilizer for the plants after demand. This way a more simple apparatus and system may be obtained without, or with a reduced, need for product storage.

The operational conditions of the electrolysis cells, including the potential and current load, may be controlled by a controller, such as a potentiostat. Further advantageously the controller is configured for both regulating the power source input to the cells, and optionally the supply of reactants and additives into the cells.

In an embodiment of the disclosure, the apparatus comprises at least one electrolysis cell and a potentiostat configured for carrying out the method according to the present disclosure.

In another embodiment of the disclosure, the apparatus comprises one or more electrolysis cells connectable to one or more power sources, and at least one controller configured for regulating the power source input to the electrolysis cells, such that the cells are operated according to a method including a step of subjecting the cathode to a continuous pulsed cathode potential, including a pulsed cathodic current load, or according to the method according to the present disclosure.

In a further embodiment, the apparatus comprises one or more power sources, preferably renewable power sources, optionally selected from the group of: wind power, hydropower, solar energy, geothermal energy, bioenergy, and mixtures thereof. In a further embodiment, the apparatus is configured as a decentralized and/or mobile unit, adapted to synthesize ammonia in amounts of 0.01-10 kg/day, more preferably 0.1-10 kg/day, and most preferably 0.1-5 kg/day, such as up to 1, 2, 3, or 4 kg/day, preferably with a Faradaic efficiency above 50%, and operated at current loads equal to or above 100 mA/cm².

### EXAMPLES

The invention is further described by the examples provided below.

### Example 1: Lithium Mediated Electrochemical Nitrogen Reduction

The measurements were done in a 3-electrode single compartment glass cell enclosed in an electrochemical autoclave. 30 mL electrolyte of 0.3 M LiClO₄ (Battery grade, dry, 99.99%, Sigma Aldrich) in 99 vol. % tetrahydrofuran (THF, anhydrous, >99.9%, inhibitor-free, Sigma Aldrich) and 1 vol. % ethanol (EtOH, anhydrous, Honeywell) was prepared in an Ar glovebox. The electrolyte was pre-saturated with purified (SAES Pure Gas, MicroTorr MC1-902F) N₂ (5.0, Air Liquide) gas for 1-2 hours at approximately 5 mL/min, in a sealed glass cell in the glovebox. This gas cleaning was done to avoid any ammonia or labile nitrogen containing contaminants in the gas itself.

The working electrode (WE) was a Mo foil (+99.9%, Goodfellow) spot-welded with Mo wire (99.85%, Goodfellow) for electrical connection. Prior to electrochemical tests, the WE was dipped in 2% HCl (VWR Chemicals) to dissolve any surface species of Li, and rinsed in ultrapure water (18.2 MΩ resistivity, Millipore, Synergy UV system), then EtOH. The WE was polished using Si—C paper (Buehler, CarbiMet P1200), and rinsed thoroughly in EtOH. The counter electrode (CE) consisted of a Pt mesh (99.9%, Goodfellow), and the reference electrode (RE) was a Pt wire (99.99%, Goodfellow). The CE and RE were both boiled in ultrapure water, and dried overnight at 100° C., then flame-annealed.

The single compartment glass cell and a magnetic stirring bar (VWR, glass covered) was cleaned in ultra pure water, and dried overnight at 100° C. The WE and CE were ˜0.5 cm apart, and the surface area of the WE facing the CE was 1.8 cm². Prior to an electrochemical experiment, we introduced Ar gas (5.0, Air Liquide) into the empty assembled cell placed in the autoclave for 1 hour. The denser Ar gas substantially displaced the atmospheric N₂ and O₂ in the system. Next, we injected electrolyte into the cell in Ar atmosphere, checked that the stirring bar in the cell was rotating despite the thickness of the autoclave bottom, and the autoclave was closed. Finally, the pressure was increased to 10 bar with either N₂ or Ar depending on the intended experiment, and de-pressurized to 3 bar a total of 9 times, then filled to 10 bar, and the electrochemical experiments were started.

The electrochemical experimental procedure included potential controlled impedance spectroscopy to determine the resistance in our cell, with 85% manual iR-drop correction, a linear sweep voltammetry (LSV) from open circuit voltage (OCV) until lithium reduction was clearly seen, then chronopotentiometry (CP), followed by another impedance measurement to ensure that the resistance has not changed. We determined the lithium reduction potential scale based on the LSV. The onset for lithium reduction was quite clear, and we thereby denoted the potential vs Li+/Li. During CP, either a steady current density of ˜2 mA/cm² was used (hereafter denoted deposition potential), or a cyclic method with ˜2 mA/cm² for 1 min, followed by 0 mA/cm² (hereafter denoted resting potential) for 3-8 min, depending on whether the WE potential needed to be increased, decreased or stabilized.

### Colorimetric Quantification of Ammonia

Synthesized ammonia was quantified by a modified colorimetric indophenol method, previously described [2]. The sample absorbance was analysed by UV/Vis spectroscopy (UV-2600, Shimadzu) in the range from 400 nm to 1000 nm. The blank solution was subtracted from each spectrum, and the difference between the peak around 630 nm and the trough at 850 nm was used. A fitted curve of the difference between the peak and trough of each concentration showed a linear regression with an R² value of 0.998. We utilized this method, as opposed to the more common peak based method, because long experiments might have solvent breakdown, which can give a falsely high peak at the ammonia wavelength, due to interference from the evolved solvent background. The amount of ammonia in the headspace was quantified by de-gassing the system through an ultrapure water trap. For each measurement, a 0.5 mL sample of the water trap was taken, and four 0.5 mL samples were taken from the electrolyte. One sample from the electrolyte was used as a background, and the mean and standard deviation of the remaining 3 samples was reported. The uncertainty reported therefore stems from the indophenol procedure. The remaining samples were treated as described previously [2], to determine the ammonia concentration. If the expected concentration of ammonia exceeded the concentration limits of the indophenol method, the sample was accordingly diluted with ultrapure water after drying.

### Example 2: Background Test—Control Experiment

Although the method described in Example 1 has been proven to synthesize ammonia, we performed a simplified version of the protocol to further validate our results.

To perform an Ar blank experiment, the electrolyte was pre-saturated with Ar instead of N₂, and after injection into the autoclave cell, the pumping and purging procedure was carried out with Ar instead of N₂. An electrochemical cycling experiment with ˜2 mA/cm² for 1 min followed by 0 mA/cm² for 3-4 minutes was carried out, with a 3 hour rest at 0 mA/cm² after around 15 hours, to allow full diffusion of any potential ammonia in solution. Additionally, ammonia contamination in blank measurements at OCV for 24 hours at 10 bar N₂, were also measured.

For Ar blank experiments, with 100.7 C passed, a background of 15±2 μg of ammonia was measured, corresponding to 0.5±0.1 p.p.m. using indophenol. NMR on a single sample gave a concentration of 0.4 p.p.m of ¹⁴NH₃ for comparison, as seen in FIG. 8.

FIG. 8 shows NMR data from using a previously developed THF suppression method [3,4]. The red curve is an Ar blank sample, magnified by 100 to show the spectra in comparison to the blue curve, which is the isotope labelled experiment with a combination of ¹⁵N₂ and ¹⁴N₂ gas (see below).

For 24-hour N₂ experiments at OCP, with pre-purging of the electrolyte with cleaned N₂ gas, 11±1 μg of ammonia was measured, corresponding to 0.4±0.1 p.p.m. We believe more ammonia was measured in the Ar blank, as there is some nitrogen in the system due to the autoclave assembly procedure. This trapped N₂ will be reduced to NH₃, leading to more in the Ar blank wherein we reduce a significant amount of lithium, as opposed to N₂ at OCP. We also inherently have a high level of contamination in our system due to the amounts of ammonia produced in regular experiments (sometimes above 100 p.p.m.), which will stick to the autoclave walls and pipes, and is unfortunately hard to get rid of. However, as we are making 1-2 orders of magnitude more ammonia in each measurement, this contamination is insignificant in comparison.

Isotope Sensitive Quantification of ¹⁵NH₃ and ¹⁴NH₃

We also carried out a single isotope labelled experiment. For the isotopically labelled nitrogen measurement, a mass spectrometer (Pfeiffer, OmniStar GSD 320) was connected to the autoclave, to determine the supplied ratio of ¹⁵N₂ to ¹⁴N₂ gas. The total internal autoclave volume was approximately 380 mL at STP, and around 320 mL of gas volume at STP with the electrochemical cell inside. To carry out the isotope experiment, we aimed for a 1:3 gas ratio of ¹⁵N₂ (98%, Sigma Aldrich) to ¹⁴N₂ at 10 bar. The pressure in the autoclave was raised to 10 bar and purged to 3 bar a total of 9 times with ¹⁴N₂, then the ¹⁵N₂ gas was added up to 5.5 bar, and lastly the ¹⁴N₂ gas up to 10 bar. The relative ratio measured via mass spectrometry was 78% ¹⁴N₂ and 22% ¹⁵N₂ supplied to the system. Two 0.5 mL samples from the electrolyte were taken after electrolysis, and one of them was diluted 5:1 to fall in the appropriate range of the calibration curve previously made. The samples were then treated according to the previously published protocols to quantitatively determine the isotope concentration of the produced ammonia via NMR, where the undiluted sample was used to ensure the desired ratio of 5 from the dilution step.

The autoclave volume was 380 cm³, and experiments were all at 10 bar, meaning we could not fill up the entire autoclave with ¹⁵N₂, as those bottles are 416 mL, and contain a total of 5 L of gas. For this reason, we aimed at utilizing a mixed composition gas of ¹⁴N₂ and ¹⁵N₂, and confirmed via mass-spectroscopy that approx. 78 vol. % ¹⁴N₂ and 22 vol. % ¹⁵N₂ was achieved. From the single NMR sample seen in FIG. 8, we measured an ¹⁵NH₃ concentration of 15.6 p.p.m. and an ¹⁴NH₃ concentration of 67.1 p.p.m, totalling 82.6 p.p.m., with 82 rel. % ¹⁴NH3 to 18 rel. % ¹⁵NH₃. The difference in concentration to the added ¹⁵N₂ and ¹⁴N₂ gas was due to the pre-saturation of the electrolyte with ¹⁴N₂, which increased the concentration of ¹⁴N₂ dissolved in the electrolyte relative to the gas phase supplied, and therefore synthesizes more ¹⁴NH₃ compared to ¹⁵NH₃. The non-isotope sensitive indophenol measurement gave 81.3±4.2 p.p.m., in perfect accordance with the NMR. A total of 2212±114μg, equalling a FE of 37.6±1.9%, and an energy efficiency of 6.5±0.4% was measured for 100 C charged passed via indophenol. This compares well with the non-isotope experiment carried out in Example 1.

### Example 3: Comparative Test—Constant Deposition

The method described in Example 1 was used, where during CP, a steady current density of ˜2 mA/cm² was used (also denoted deposition potential). The resulting electrode potentials as a function of time for lithium mediated ammonia synthesis under the constant cathodic current load of ˜2 mA/cm² are shown in FIG. 5. The constant deposition measurements shown in FIG. 5 were repeated 3 times and all of them overloaded within 2.5 hours. The mean FE of the measurements was amount of ammonia made was 21.2±1.6%, with a mean energy efficiency 2.3±0.3%.

The 3 separate experiments of FIG. 5 were done at a constant current deposition at ˜2 mA/cm² (lighter grey curve, related to the grey y-axis to the right), for 3 separate experiments (solid, and two dashed black curves) with some charge passed (black curve, related to the right y-axis) depending on when the experiment overloaded. The working electrode potential (solid, dashed and stipled black curves, related to the left y-axis) drifts more negative (from 0 V vs Li⁺/Li to around ˜12 V vs Li⁺/Li), increasing the energy input required to sustain the desired current density. The CE potential (solid, and two dashed grey curves, related to the left y-axis) is stable throughout the experiment (around 5 V vs Li⁺/Li). After around 40 min, the experiment has a significant decrease in WE potential, leading to an eventual overload, most likely due to passivation of the electrode

As is seen from FIG. 5, the process is not stable over long time. It is speculated that as the lithium salt is reduced, not all of the metallic lithium undergoes nitridation, leading to fresh lithium depositing onto metallic lithium that does not form ammonia. This decreases the overall efficiency of the system, and decreases the ionic conductivity of the solution as the lithium ions are depleted from solution, thereby increasing the overall resistance in the cell. The continuous deposition of lithium thus limits the up-scalability of the process, as a continued supply of lithium salt would be required to sustain synthesizing ammonia. This also leads to an accumulation of lithium species on the electrode surface, which slowly increases the needed potential to run the reaction.

In conclusion, it has proved difficult to achieve a stable WE potential while applying a constant current, which continuously reduces lithium. Due to high sensitivity of the system to small amounts of O₂ and H₂O, which reacts with the deposited lithium layer forming passivated compounds, the potential needed to maintain a given current increases. Furthermore, if the lithium deposition occurs at a very high rate, metallic lithium is deposited on top of metallic lithium that has not yet reacted to form lithium nitride. This leads to an inefficiency in the system, as charge is wasted depositing excess lithium, which will react and not generate ammonia, and there will be a slow build-up of lithium on the electrode. Over long experiments, this decreases the salt concentration, while increasing the resistance of the cell due to lowering the conductivity and increasing the electrode resistance.

### Example 4: Cyclic Stabilization

The method described in Example 1 was used, where the method consisted of short deposition pulses of 1 min at ˜2 mA/cm² followed by 3-8 min at 0 mA/cm², as seen in FIGS. 6-7.

FIG. 6 shows cycling method between ˜2 and 0 mA/cm² (light grey curve, related to the grey y-axis to the right), for a total of 100 C of charge passed (black curve, related to the black y-axis to the right). The working electrode potential (black curve, related to the y-axis to the left) is roughly stable (around 0 V vs Li⁺/Li) across the entire experiment by varying the resting time. The CE potential (darker grey curve, related to the y-axis to the left) is also stable (around 4 V vs Li⁺/Li).

FIG. 7 shows a close up of the cycling. Immediately after switching from 0 mA/cm² to a deposition current of ˜2 mA/cm², the WE potential increased for the entire 1 min duration. When switching back to resting (i.e. 0 mA/cm²), the WE potential was initially stable around −3 V (corresponding to 0 V vs Li⁺/Li), until it eventually started decreasing after some minutes, due to lithium species fully dissolving from the surface. At this point, another Li depositing pulse was applied.

It was seen that the instability issue described in Example 3 due to build-up of lithium species on the surface of the electrode, was avoided when using the cyclic method. Applying short current pulses for lithium deposition, with a resting time between each pulse to allow the lithium to react fully with nitrogen in solution significantly prevented the WE potential from drifting cathodic over time.

It is speculated that this is due to the absence of significant unreactive lithium species build-up on the electrode in the cyclic method, since it provides time for the deposit to chemically react with our electrolyte, and dissolve from the surface, as seen by the change of the WE potential during the resting time, FIG. 7. By increasing/decreasing the resting time, we could accurately decrease/increase the WE potential, and keep it stable during deposition. This is seen as the change in the slope of the charge, which correlates with a change in the resting time.

The measurement shown in FIGS. 6-7 made 2143±22 μg (72.6±0.7 p.p.m.) of NH₃, equaling a FE of 36.4±0.4%, and an energy efficiency of 7.4±0.1%, significantly higher than the constant current deposition benchmark experiments of Example 3. We speculate that the cycling procedure stabilizes the WE potential because it “resets” the surface by removing the deposited material, and replenishes the lithium in the solution, which also enables us to keep the overall WE potential quite low. The Faradaic efficiency also increases with the continuous cycling method, as charge is not wasted on forming unreactive lithium deposits. Furthermore, the overall energy efficiency is improved, due to the decrease in needed potential to sustain the same current, and the overall increase in FE.

The cyclic method further has the advantage that the potential is cycled from a very negative lithium reducing potential, to a less negative potential at which lithium is not reduced, while potentially still synthesizing ammonia. This leads to both a vast improvement of stability of the system, and a significant increase in energy efficiency. The cycling enables the reduced metallic lithium to react with nitrogen at a lower potential without depositing more lithium, thereby fully forming the nitride and producing ammonia. The lithium in solution will also not deplete over time, as all the plated lithium has time to dissolve from the surface of the cathode, thereby stabilizing the working electrode potential. Furthermore, the overall energy efficiency of the cycling will be higher compared to the continuous deposition process, as ammonia could be formed at potentials less negative than −3 V vs RHE.

In conclusion, the electrochemical lithium mediated nitrogen reduction process with a constant applied potential or current described in Example 3, resulted in constant deposition of lithium onto the WE invariably leading to a build up of unreactive species on the surface, increasing the needed potential to continue running the experiment over time. The issue was circumvented by the cycling method, wherein lithium was reduced for 1 min at ˜2 mA/cm², and then allowed to rest at 0 mA/cm² for a variable time of 3-8 min, until the surface species of lithium was chemically dissolved. This assured a high lithium concentration near the surface of the electrode, and allowed for fine control of the WE potential throughout the experiment.

Furthermore, due to the increase in FE during the cycling compared to constant deposition, it is suspected that ammonia is formed during the resting time, wherein no current is passed. This significantly increases the energy efficiency of the system, beyond anything previously reported.

### Example 5: Long-Term Experiment

Based on Example 4, a long-term experiment spanning 125 hours and passing 180 C was carried out. By varying the resting potential time, the WE potential was controlled to be in the desired low potential region across the entire experiment, with the CE potential reaching a maximum of 5 V vs Li+/Li. This experiment used 2 vol. % EtOH instead of 1 vol. %, as passing such large amounts of charge would significantly impact the total EtOH concentration throughout the experiment. The proton source must eventually be replenished in this system, as the current source is EtOH oxidation on the CE.

This experiment made 3470±104 μg (110.9±3.5 p.p.m.), equaling a FE of 33.1±0.1%, and an energy efficiency of 5.3±0.2%. We speculate the slightly lower yield is due to the increase in EtOH concentration, as that has previously been shown to impact the faradaic efficiency, however this experiment still had a higher FE and energy efficiency compared to the constant deposition.

A continuous deposition experiment with lithium, wherein there is a perfect balance between the amount deposited, and the amount of Li dissolving when synthesizing ammonia, may be carried out.

Even if not all the deposited lithium forms a nitride, but some other non-reactive or passive deposits are also formed, which builds up on—and eventually passivates—the electrode, during the resting cycle, the lithium species have enough time to chemically dissolve, mitigating a build-up on the electrode.

Visually, the electrode surface of the constant deposition experiment of Example 3 had big deposits of lithium species on the surface, shown in FIG. 4A. These deposits led to the instability in the system shown in FIG. 5, as it slowly passivates the electrode. The surface of the Mo foil used for passing 180 C over 125 hours was visually much cleaner and smoother, as seen in FIG. 4B. This correlated well with the experiment being stable and reproducible over long periods, as the lithium immediately near the electrode surface is repeatedly reduced and reacted off in the cycling process.

Furthermore, the increase in FE and energy efficiency during the cycling compared to constant deposition implied that ammonia was formed even during the resting periods, wherein the WE potential was lower than the lithium reduction potential and no net current flows.

### Example 6: Flow Cell

The measurements of Examples 4-5 may be repeated using a flow cell instead of the 3-electrode single compartment glass cell. For example, the measurements may be carried out in a flow cell as shown in FIG. 3, where nitrogen is supplied to the electrolyte as a continuous gas flow, and hydrogen is supplied as a continuous gas flow.

### Example 7: Cation Mediated Electrochemical Nitrogen Reduction

The 30 mL electrolyte of 0.3 M LiClO₄ of Examples 1, 4 and 5 may be substituted with an electrolyte comprising one or more metal cations, where the metal is lithium (Li), sodium (Na), potassium (K), magnesium (Mg), calcium (Ca), barium (Ba), and/or yttrium (Y).

Examples 4 and 5 are repeated, and similar ammonia synthesis with improved efficiency and stability, by use of the pulsed cathode potential, including a pulsed cathodic current load, can be obtained.

### Items

The presently disclosed may be described in further detail with reference to the following items.
1. A method for electrochemical ammonia synthesis, comprising the steps of:
   providing an electrolysis cell having a cathode,
   contacting the cathode with a source of cations, nitrogen, and protons, and
   subjecting the cathode to a continuous pulsed cathode potential, including a pulsed cathodic current load, whereby ammonia is synthesized.
2. The method according to item 1, wherein the cathode potential is pulsed between a first cathode potential, including a first cathodic current load, and a second cathode potential, including a second cathodic current load.
3. The method according to any of the preceding items, wherein the cathode potential is pulsed between the cation reduction potential and a less negative cathode potential.
4. The method according to any of the preceding items, wherein the cations are one or more metal cations, where the metal is selected from groups 1-13 of the periodic table and combinations thereof, more preferably the metal is selected from the group consisting of: alkali metals, alkali or alkaline earth metals, and/or transition metals, more preferably the metal is selected from groups 1, 2, 3 of the periodic table and combinations thereof, and most preferably the metal is selected from the group consisting of: lithium (Li), sodium (Na), potassium (K), magnesium (Mg), calcium (Ca), barium (Ba), yttrium (Y), and combinations thereof.
5. The method according to any of the preceding items, wherein the cathode potential is pulsed between the lithium reduction potential and a less negative cathode potential.
6. The method according to item 5, wherein the cathode potential is pulsed between the lithium reduction potential and the cell OCP.
7. The method according to any of items 2-5, wherein the duration of the pulses at the first cathode potential is between 0.5-60 min, more preferably between 0.7-30 min, and most preferably between 0.8-10 min, such as 1 or 2 min.
8. The method according to any of the preceding items, wherein the duration of the pulses at the second cathode potential is between 1-120 min, such as 1 or 2 min, more preferably between 2-60 min, and most preferably between 3-30 min, such as 3-5 or 10 min.
9. The method according to any of the preceding items, wherein the pulses at the first cathodic current load has a duration of between 0.5-60 min, more preferably between 0.7-30 min, and most preferably between 0.8-10 min, such as 1 or 2 min.
10. The method according to any of the preceding items, wherein the pulses at the second cathodic current load has a duration of between 1-120 min, such as 1 or 2 min, more preferably between 2-60 min, and most preferably between 3-30 min, such as 8 or 10 min.
11. The method according to any of the preceding items, wherein the pulsed cathodic current load is pulsating DC and/or pulsating AC.
12. The method according to any of the preceding items, wherein the pulses at the first cathodic current load has a current density below −1 mA/cm², such as −2, −5, or −10 mA/cm², more preferably above −50 mA/cm2, such as −60, −70, −80, −90, or −100 mA/cm².
13. The method according to any of the preceding items, wherein the pulses at the second cathodic current load has a current density above −0.5 mA/cm², such as 0 mA/cm² or 0.1 mA/cm².
14. The method according to any of the preceding items, wherein the temperature is between 10-150° C., more preferably between 20-130° C., and most preferably between 25-120° C., such as 50 or 100° C.
15. The method according to any of the preceding items, wherein the pressure is equal to or below 20 bar, such as 15, 10, 5, 1 bar or ambient pressure.
16. The method according to any of items 4-15, wherein the source of Li ions is selected from the group consisting of: molten Li salt, Li solutions, and combinations thereof, such as LiClO₄ solutions.
17. The method according to item 16, wherein the solutions has a Li concentration below 3 M or 1 M, such as 0.1, 0.2, 0.5, or 2 M.
18. The method according to any of the preceding items, wherein the source of nitrogen is selected from the group consisting of: gaseous N₂, liquidly dissolved N₂, and combinations thereof.
19. The method according to any of the preceding items, wherein the source of protons is selected from the group consisting of: gaseous H₂, liquidly dissolved H₂, aprotic solvents, ethanol (EtOH), alkyl alcohols, tert-butanol, perfluorinated alcohols, polyethyleneglycols, ethanethiol, alkyl thiols, alkyl ketones, alkyl esters and combinations thereof.
20. The method according to item 19, wherein the aprotic solvent is selected from the group consisting of: tetrahydrofuran (THF), ethanol (EtOH), and combinations thereof, such as THF-1 vol % EtOH.
21. The method according to any of items 19-20, wherein the concentration of the protons within the proton source is between 0.01-100 vol %, more preferably between 0.01-5 vol %, and most preferably between 0.05-3 or 0.1-2 vol %.
22. The method according to any of items 19-21, wherein the source of protons is combined with a proton exchange membrane.
23. The method according to any of the preceding items, further comprising an essentially aprotic solvent, selected from the group of: tetrahydrofuran (THF), oxane, diethyl ether, dipropyl ether, diglyme, dimethoxyethane, triglyme, tetraglyme, polyethyleneglycol alkyl ethers, dioxane, organic carbonates, e.g. dimethyl carbonate, ethylene carbonate, diethyl carbonate, ethyl methyl carbonate, propylene carbonate, dialkyl carbonates, butyrolactone, cyclopentanone, cyclohexanone, sulfolane, ethylene sulfate (DTD), trimethylglycerol, and mixtures thereof, and preferably is selected from the group of: tetrahydrofuran, organic carbonates, propylene carbonate, and mixtures thereof.
24. The method according to item 23, wherein the essentially aprotic solvent comprises one or more additives selected from the group of: perfluorinated hydrocarbons, perfluorinated ethers, highly fluorinated organic tetrakisalkyl phosphonium perfluorinated phosphates, tetrakisalkyl phosphonium perfluoroalkyl sulfonates, tetrakisalkyl phosphonium perfluoroalkyl carboxylates, crown ethers, and mixtures thereof.
25. The method according to item 24, wherein the concentration of the additives is between 0-100 vol %, more preferably between 0.01-5 vol %, and most preferably between 0.05-3 or 0.1-2 vol %.
26. The method according to any of the preceding items, wherein the electrolysis cell is selected from the group consisting of: single compartment cells, and flow cells.
27. An apparatus for electrochemical ammonia synthesis, comprising an electrolysis cell and a potentiostat, wherein the potentiostat is configured for carrying out the method according to any of items 1-26.
28. An apparatus for electrochemical ammonia synthesis, comprising
   at least one electrolysis cell having a cathode, said electrolysis cell connectable to at least one power source, and
   at least one controller configured for regulating the power source input to the electrolysis cells,
      wherein wherein the apparatus is configured for
   contacting the cathode with a source of lithium cations, nitrogen, and protons, and
   subjecting the cathode to a continuous pulsed cathode potential, including a pulsed cathodic current load, wherein the cathode potential is pulsed between the lithium reduction potential and a less negative cathode potential.
29. The apparatus according to item 28, configured to carry out the method of any of items 1-26.
30. The apparatus according any of items 27-29, comprising one or more power sources, preferably renewable power sources, optionally selected from the group of: wind power, hydropower, solar energy, geothermal energy, bioenergy, and mixtures thereof.
31. The apparatus according to any of items 27-30, wherein the apparatus is configured as a decentralized unit and/or mobile unit, and adapted to synthesize ammonia in amounts of between 0.01-10 kg/day, more preferably 0.1-10 kg/day, and most preferably 0.1-5 kg/day, such as up to 1, 2, 3 or 4 kg/day.

### REFERENCES

[1] WO 2012/129472.
[2] P. L. Searle, “The Berthelot or indophenol reaction and its use in the analytical chemistry of nitrogen. A review,” Analyst, vol. 109, no. 5, p. 549, 1984.
[3] S. Z. Andersen et al., “A rigorous electrochemical ammonia synthesis protocol with quantitative isotope measurements,” Nature, vol. 570, no. 7762, pp. 504-508, 2019.
[4] A. C. Nielander et al., “A Versatile Method for Ammonia Detection in a Range of Relevant Electrolytes via Direct Nuclear Magnetic Resonance Techniques,” ACS Catal., vol. 9, no. 7, pp. 5797-5802, Jul. 2019.

1. A method for electrochemical ammonia synthesis, comprising the steps of:
providing at least one electrolysis cell,
contacting a cathode of said electrolysis cell with a source of lithium cations, nitrogen, and protons, and
subjecting the cathode to a continuous pulsed cathode potential including a pulsed cathodic current load, wherein the cathode potential is pulsed between a first cathode potential at a lithium reduction potential and a second cathode potential, the second cathode potential less negative that the first cathode potential, whereby ammonia is synthesized.

2. The method according to claim 1, wherein the cathode potential is pulsed between the lithium reduction potential and the cell OCP.

3. The method according to claim 1, wherein a duration of pulses at the first cathode potential is between 0.5-60 min.

4. The method according to claim 1, wherein the duration of pulses at the second cathode potential is between 1-120 and/or wherein the pulses at a first cathodic current load has a duration of between 0.5-60 min.

5. The method according to claim 1, wherein the pulses at a second cathodic current load has a duration of between 1-120 min.

6. The method according to claim 1, wherein the pulsed cathodic current load is pulsating DC and/or pulsating AC.

7. The method according to claim 1, wherein the pulses at a first cathodic current load has a current density below −1 mA/cm²and/or wherein the pulses at a second cathodic current load has a current density above −0.5 mA/cm².

8. The method according to claim 1, wherein the source of Li ions is selected from the group consisting of: molten Li salt, Li solutions, and combinations thereof.

9. The method according to claim 1, wherein the source of nitrogen is selected from the group consisting of: gaseous N₂, liquidly dissolved N₂, and combinations thereof.

10. The method according to claim 1, wherein the source of protons is combined with a proton exchange membrane.

11. The method according to claim 1, wherein the electrolysis cell is selected from the group consisting of: single compartment cells, and flow cells.

12. An apparatus for electrochemical ammonia synthesis, comprising
at least one electrolysis cell having a cathode, said electrolysis cell connectable to at least one power source, and
at least one controller configured for regulating the power source input to the electrolysis cells,
wherein the apparatus is configured for
contacting the cathode with a source of lithium cations, nitrogen, and protons, and
subjecting the cathode to a continuous pulsed cathode potential, including a pulsed cathodic current load, wherein the cathode potential is pulsed between a lithium reduction potential and a less negative cathode potential.

13. The apparatus according to claim 12, configured to carry out the method of claim 1.

14. The apparatus according to claim 12, comprising one or more power sources.

15. The apparatus according to claim 12, wherein the apparatus is configured as a decentralized unit and/or mobile unit, and adapted to synthesize ammonia in amounts of between 0.01-10 kg/day.

16. The apparatus according to claim 13 comprising a potentiostat.

17. The apparatus according to claim 14, wherein the power source is a renewable power source.

18. The method according to claim 8, wherein the solution has a Li concentration below 3 M or 1 M.

19. The method according to claim 1, wherein the source of protons is selected from the group consisting of: gaseous H₂, liquidly dissolved H₂, aprotic solvents, ethanol (EtOH), alkyl alcohols, tert-butanol, perfluorinated alcohols, polyethyleneglycols, ethanethiol, alkyl thiols, alkyl ketones, alkyl esters and combinations thereof.

20. The method according to claim 1, wherein the temperature is between 10-150° C. and/or wherein the pressure is equal to or below 20 bar.
